(19) United States
(12) Patent Application Publication
(10) Pub. No.: US 2018/0056950 A1
(43) Pub. Date: Mar. 1, 2018

(54) HAND OPERATED ELECTRONIC PARKING BRAKE SYSTEM WITH AN ADJUSTABLE LOAD SIMULATOR

(71) Applicant: Dura Operating, LLC, Auburn Hills, MI (US)

(72) Inventors: Brian Edward Steakley, Chesterfield, MI (US); Nolan Robert Maryanski, Rochester, MI (US)

(21) Appl. No.: 15/586,690

(22) Filed: May 4, 2017

Related U.S. Application Data
(60) Provisional application No. 62/380,765, filed on Aug. 29, 2016.

(51) Int. Cl. B60T 7/08; B60T 7/10; G05G 5/03

(52) U.S. Cl. CPC B60T 7/085; G05G 5/03; B60T 7/102

(57) ABSTRACT

A motor vehicle electric park brake system includes a hand brake lever mechanism in electronic communication with a park brake. The hand brake lever mechanism includes a brake lever pivotally supported to a mounting bracket. A biasing member exerts a torque on the brake lever as the brake lever rotates from a disengaged position to an engaged position to simulate a mechanical connection between the brake lever mechanism and the park brake. An adjustment mechanism is displaced to adjust the biasing member to change the torque on the brake lever.

### CROSS-REFERENCE TO RELATED APPLICATIONS

This application claims the benefit of U.S. Provisional Application No. 62/380,765 filed on Aug. 29, 2016. The entire disclosure of the above application is incorporated herein by reference.

### FIELD

The present disclosure relates generally to a hand operated electronic parking brake system, and more particularly to a hand operated electronic brake system with an adjustable load simulator.

### BACKGROUND

The statements in this section merely provide background information related to the present disclosure and may or may not constitute prior art.

Park brake systems in motor vehicles generally include a hand operated brake lever that engages and disengages a park brake. The park brake may be used to prevent the wheels of the motor vehicle from rotating and may act as a backup to the park pawl associated with the shift lever of the motor vehicle. The park brake typically engages the rear axle or wheels of the motor vehicle and prevents rotation of the rear axle or wheels when the park brake is engaged.

Park brake systems include mechanical park brake systems and electronic park brake systems. Mechanical park brake systems include a cable connected between the hand operated brake lever and the park brake. An operator of the motor vehicle engages the park brake by actuating the hand brake lever from an unengaged position to an engaged position. Movement of the hand brake lever moves the cable which in turn engages the park brake. Electronic park brake systems, or park brake-by-wire systems, do not include a mechanical connection between the hand brake lever and the park brake. Instead, the position of the hand brake lever is sensed and the park brake is electronically commanded to engage or disengage based on the sensed position of the hand brake lever. While these systems are useful for their intended purpose, the electronic park brake systems lack the haptic feedback of the mechanical park brake system. Thus, there is a need in the art for an electronic park brake system that applies an adjustable load to the hand brake lever to provide haptic feedback to an operator of the motor vehicle.

### SUMMARY

An electronic park brake system with an adjustable load simulator is provided. The electronic park brake system includes a hand operated brake lever in electronic communication with a park brake. The hand operated brake lever includes a lever pivotally mounted to a mounting bracket. At least one torsion spring is connected at one end to the mounting bracket and at another end to the lever. The torque supplied by the torsion spring to the brake lever is adjustable by an adjustment mechanism.

Further aspects, examples, and advantages will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is an isometric view of a hand operated electronic park brake system according to the principles of the present disclosure;

FIG. 2 is a side view of a brake lever with an outer cover removed;

FIG. 3 is an isometric exploded view of the brake lever;

FIG. 4 is an isometric view of a second embodiment of a brake lever in a first position;

FIG. 5 is an isometric view of the second embodiment of the brake lever in a second position;

FIG. 6 is an isometric exploded view of the second embodiment of the brake lever;

FIG. 7 is an isometric view of a third embodiment of a brake lever in a first position;

FIG. 8 is an isometric view of the third embodiment of the brake lever in a second position; and

FIG. 9 is an isometric exploded view of the third embodiment of the brake lever.

### DETAILED DESCRIPTION

The following description is merely exemplary in nature and is not intended to limit the present disclosure, application, or uses.

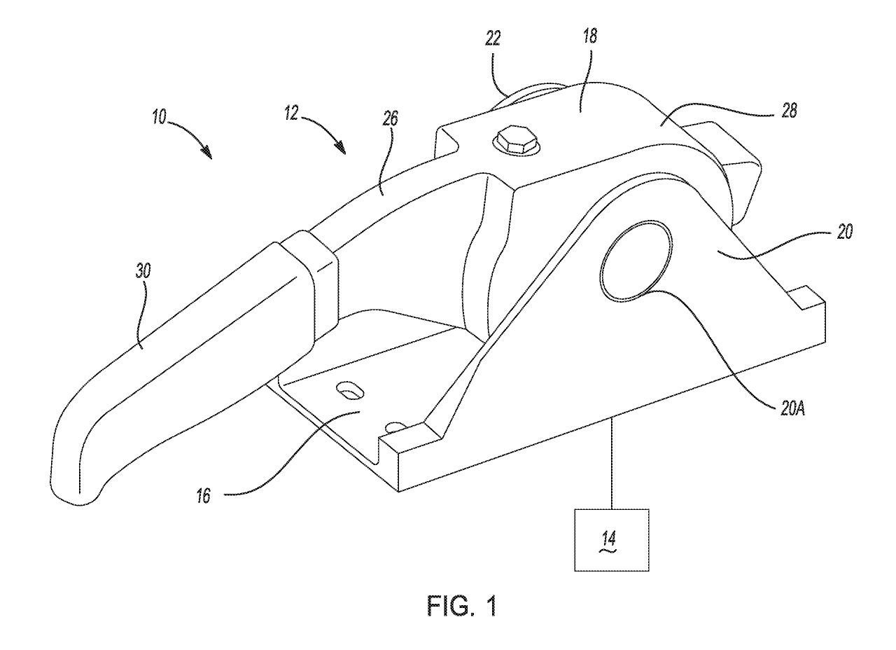

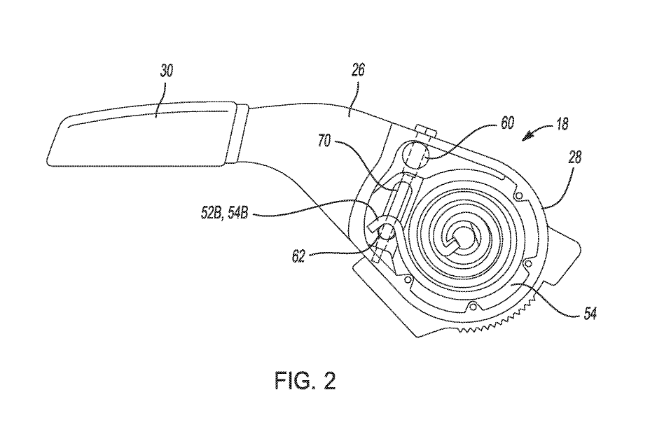

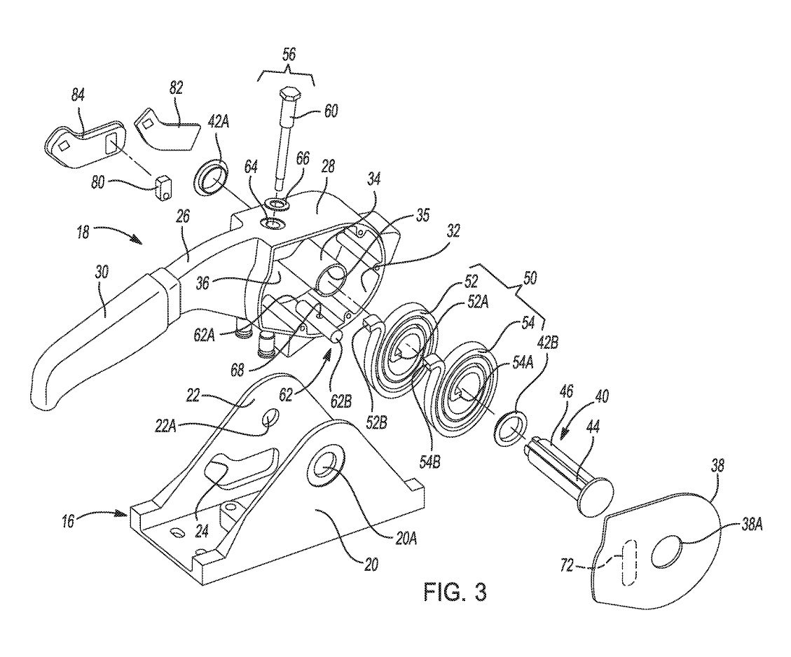

With reference to FIGS. 1-3, an electronic hand operated park brake system for a motor vehicle is generally indicated by reference number 10. The park brake system 10 includes a hand brake lever mechanism 12 in electronic communication with a park brake 14. The park brake 14 is operable to prevent rotation of one or more road wheels (not shown) in the motor vehicle. For example, the park brake 14, when engaged, prevents a front or rear axle (not shown) of the motor vehicle from rotating. The park brake 14, when disengaged, allows the front or rear axle to rotate freely.

The hand brake lever mechanism 12 includes a mounting bracket 16 which pivotally supports a brake lever 18. The mounting bracket 16 is preferably fixed to the motor vehicle and includes a first bracket 20 parallel to a second bracket 22. The first bracket 20 includes a first hole 20A while the second bracket 22 includes a second hole 22A. The first hole 20A is coaxial with the second hole 22A. The second bracket 22 further includes an angled window 24.

The brake lever 18 includes a lever arm 26 extending from a housing portion 28. A hand grip 30 is disposed on a distal end of the lever arm 26. The lever arm 26 and hand grip 30 are configured to be actuatable by a user of the motor vehicle to engage the park brake 14.

The housing portion 28 defines an inner cavity 32. A center support 34 extends out from a side wall 36 into the inner cavity 32. The center support 34 is open at both ends and is hollow. The center support 34 includes a longitudinal slot 35 that extends through the center support 34 such that the center support 34, viewed end-on, has a substantially “C” shape. A side cover 38 is connected to the housing portion 28 opposite the side wall 36 to enclose the inner cavity 32. The side cover 38 includes a hole 38A that extends there through. The hole 38A is in coaxial alignment with the center support 34.

A pivot pin or rivet 40 pivotally supports and connects the brake lever 18 to the mounting bracket 16. The pivot pin 40 extends through the holes 20A, 22A in the first and second brackets 20, 22, through the hole 38A in the side cover 38 and through the center support 34 of the brake lever 18. A pair of bushings 42A, 42B are disposed at each end of the pivot pin 40 between the pivot pin 40 and the brake lever 18. The pivot pin 40 is fixed from rotating relative to the mounting bracket 16 by, for example, a key, a fastener, a weld, or the like. The brake lever 18, which supported on the pivot pin 40 by the center support 34, is rotatable about the pivot pin 40. The pivot pin 40 includes a groove 44 formed in an outer surface 46 of the pivot pin 40.

The hand brake lever mechanism 12 further includes a biasing member 50 configured to exert a torque on the brake lever 18 in order to simulate a mechanical connection between the brake lever mechanism 12 and the park brake 14. In the example provided, the biasing member 50 includes a first torsion spring 52, a second torsion spring 54, and an adjustment mechanism 56. In a preferred embodiment, each torsion spring 52, 54 is configured to provide half of a desired torque to simulate the mechanical connection between the brake lever mechanism 12 and the park brake 14 to increase the lifetime of the brake lever mechanism 12 while minimizing size and cost. However, it should be appreciated that any number of torsion springs may be employed without departing from the scope of the present disclosure. In addition, alternative biasing members may be used, as will be described below.

The first torsion spring 52 is disposed about the center support 34 and includes an inner end 52A and an outer end 52B. The inner end 52A extends through the slot 35 in the center support 34 and engages the groove 44 in the pivot pin 40. Thus, the inner end 52A of the first torsion spring 52 is fixed from movement with the mounting bracket 16. The outer end 52B is connected to the adjustment mechanism 56 and moves with the rotation of the brake lever 18.

The second torsion spring 54 is disposed adjacent the first torsion spring 52 and is disposed about the center support 34. The second torsion spring 54 includes an inner end 54A and an outer end 54B. The inner end 54A extends through the slot 35 in the center support 34 and engages the groove 44 in the pivot pin 40. Thus, the inner end 54A of the first torsion spring 54 is fixed from movement with the mounting bracket 16. The outer end 54B is connected to the adjustment mechanism 56 and moves with the rotation of the brake lever 18.

The adjustment mechanism 56 is used to adjust the torque provided by the first and second torsion springs 52, 54 on the brake lever 18 by changing how much the first and second torsion springs 52, 54 are axially twisted. The adjustment mechanism 56 includes an adjuster such as a threaded bolt 60 and an adjustment pin 62. The threaded bolt 60 extends through a bolt-hole 64 in the housing portion 28 into the inner cavity 32. A washer 66 may be disposed between the threaded bolt 60 and the housing portion 28. The adjustment pin 62 includes a threaded bolt-hole 68 which receives the threaded bolt 60. The adjustment pin 62 is disposed perpendicular to the threaded bolt 60 and has a first end 62A opposite a second end 62B. The first end 62A is disposed in a first groove 70 formed in the side wall 36 of the housing portion 28 while the second end 62B is disposed in a second groove 72 formed in the side cover 38. The first and second grooves 70, 72 limit the travel of the adjustment pin 62. The outer ends 52B, 54B of the first and second torsion springs 52, 54 are hooked onto the adjustment pin 62. By rotating the threaded bolt 60, the adjustment pin 62 slides within the first and second grooves 70, 72 and moves the outer ends 52B, 54B of the torsion springs 52, 54 either up or down thus adjusting the torque.

According the further aspects, if only a single torsion spring is used, the adjuster or adjustment pin 62 can be replaced by a yoke through which the threaded bolt 60 passes, the yoke having a substantially rectangular shaped aperture that receives the outer end of the torsion spring. By rotating the threaded bolt 60, the yoke displaces and moves the outer end such as the outer end 52B of the torsion spring 52 either up or down thus adjusting the torque.

In order to detect a position of the brake lever 18, the park brake system 10 includes a switch 80 mounted to the brake lever 18 and a sensor 82 mounted to the mounting bracket 16. The sensor 82 detects a position of the switch 80 through the angled window 24. A cover 84 is disposed overtop the sensor 82. The sensor 82 may communicate with a controller or directly with the park brake 14. Movement of the brake lever 18 is detected by the sensor 82 and, based on a position of the brake lever 18, the park brake 14 may be commanded to engage or disengage.

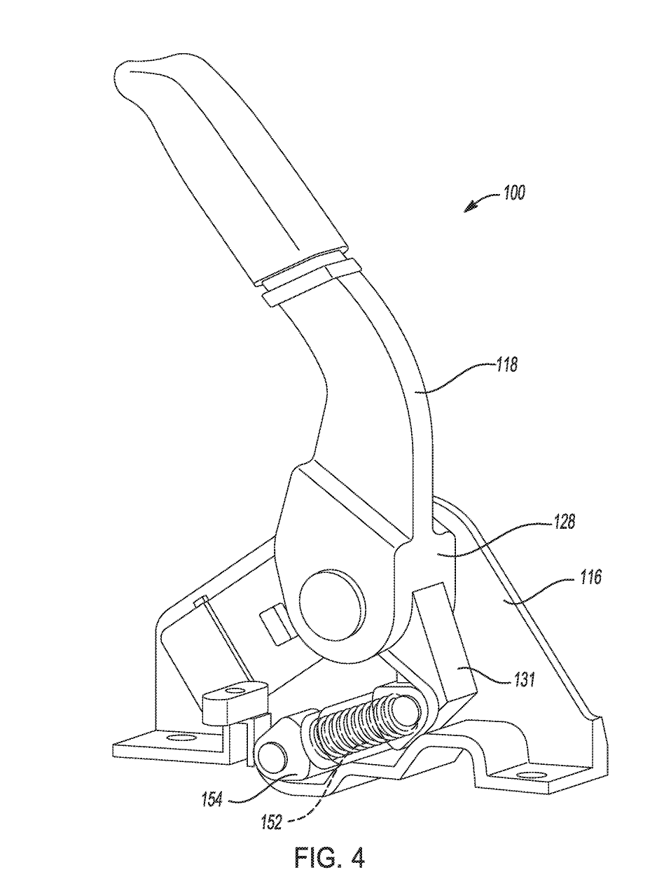

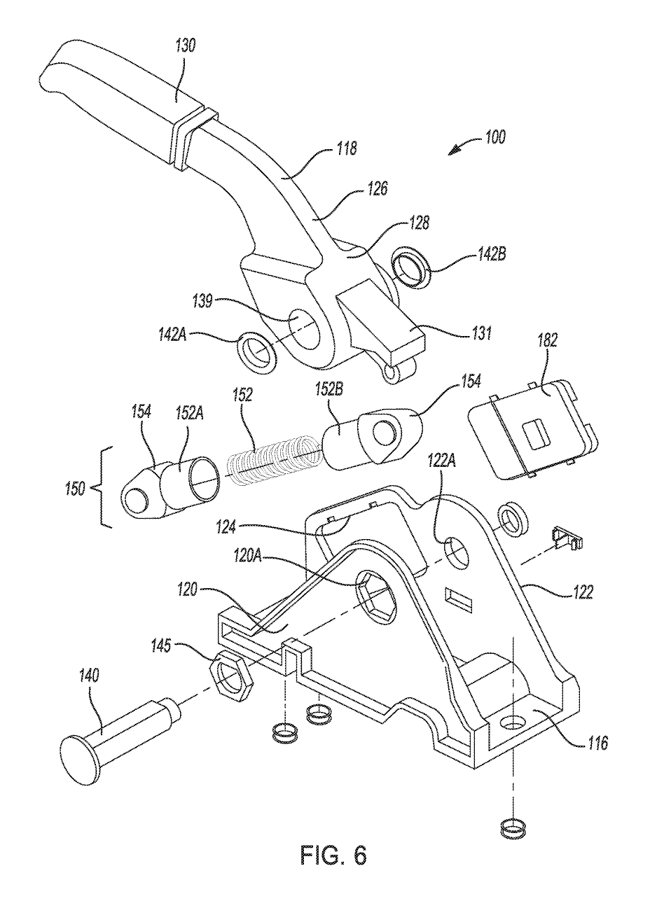

Turning now to FIGS. 4-6, another embodiment of a hand brake lever mechanism is indicated by reference number 100. The brake lever mechanism 100 includes a mounting bracket 116 which pivotally supports a brake lever 118. The mounting bracket 116 is preferably fixed to the motor vehicle and includes a first bracket 120 parallel to a second bracket 122. The first bracket 120 includes a first hole 120A while the second bracket 122 includes a second hole 122A. The first hole 120A is coaxial with the second hole 122A. The second bracket 122 further includes an angled window 124.

The brake lever 118 includes a lever arm 126 extending from a housing portion 128. A hand grip 130 is disposed on a distal end of the lever arm 126. The lever arm 126 and hand grip 130 are configured to be actuatable by a user of the motor vehicle to engage the park brake 14. A second lever arm 131 extends from the housing portion 128 on a side of the housing portion 128 opposite that of the lever arm 126.

A pivot pin or rivet 140 pivotally supports and connects the brake lever 118 to the mounting bracket 116. The pivot pin 140 extends through the holes 120A, 122A in the first and second brackets 120, 122, and through a hole 139 in the housing portion 128 of the brake lever 118. A pair of bushings 142A, 142B may be disposed at each end of the pivot pin 140. The pivot pin 140 is fixed from axially rotating relative to the mounting bracket 116 by, for example, a key 145, a fastener, a weld, or the like. The brake lever 118, supported on the pivot pin 140, is rotatable about the pivot pin 140.

A biasing member 150 is configured to exert a torque on the brake lever 118 in order to simulate a mechanical connection between the brake lever mechanism 100 and the park brake 14. In the example provided, the biasing member 150 includes a die or coiled spring 152. The spring 152 includes a first end 152A pivotally connected to the mounting bracket 116 and a second end 1526 pivotally connected to the second lever arm 131 of the brake lever 118. The spring 152 is preferably enclosed in a two-piece cylindrical housing 154. A position of the brake lever 118 is sensed by a sensor 182 mounted in the angled window 124.

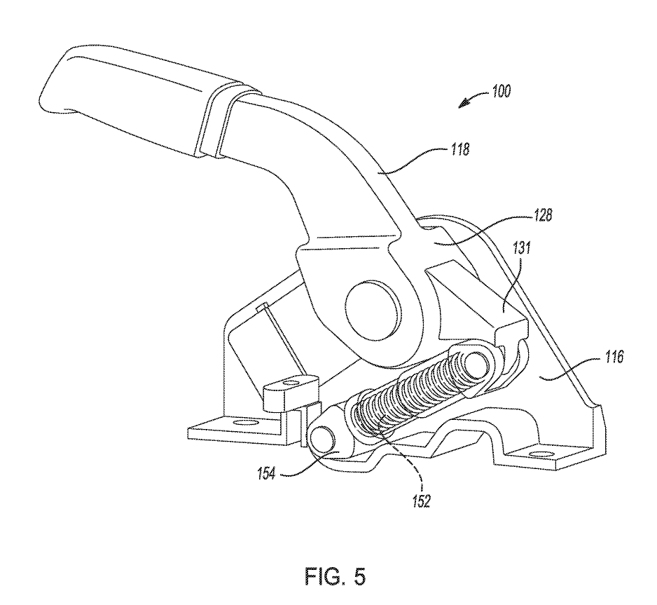

Pivoting the brake lever 118 from the disengaged position, shown in FIG. 5, to the engaged position, shown in FIG. 4, compresses the spring 152. Thus, the spring 152 generates a force resisting rotation of the brake lever 118 as the brake lever moves from the disengaged position toward the engaged position, which thereby exerts torque on the brake lever 118.

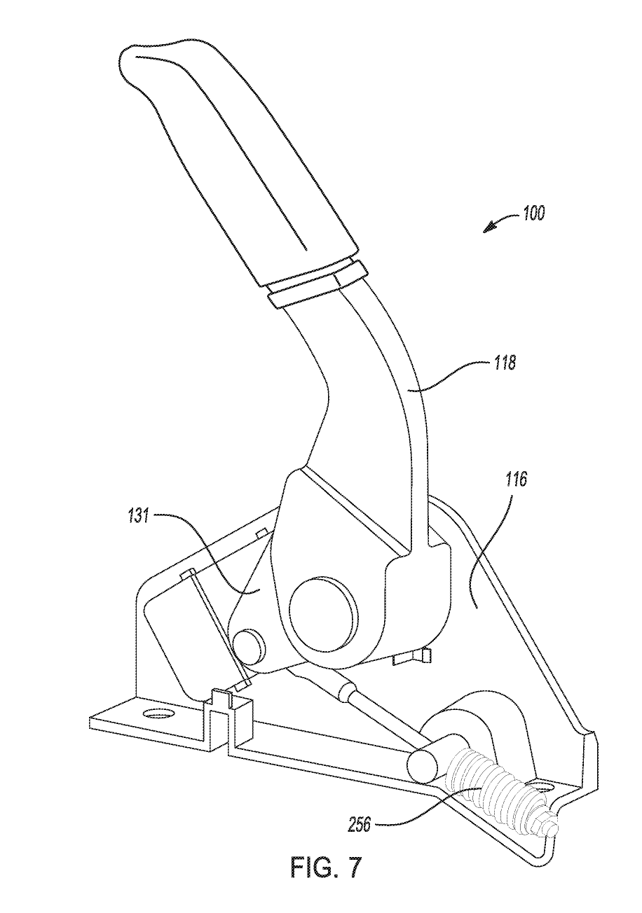

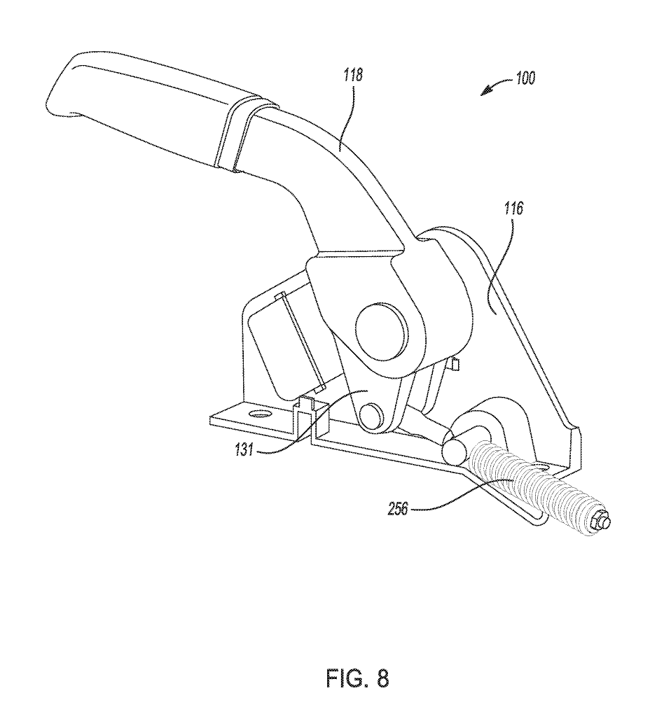

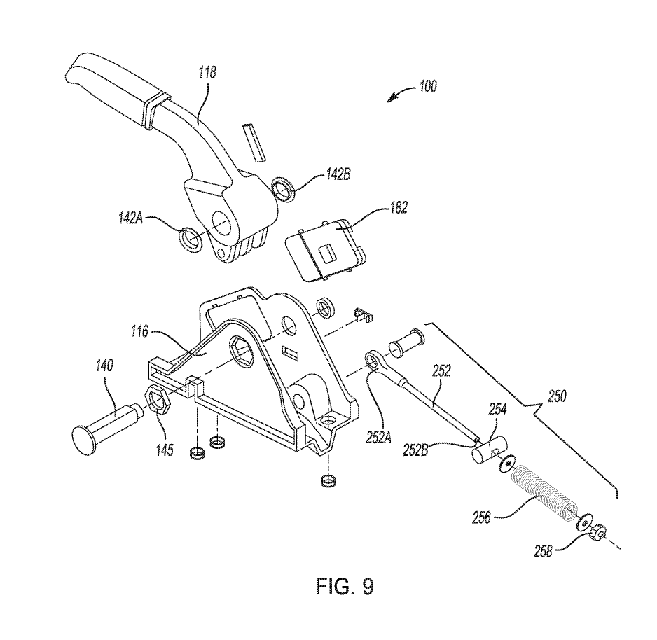

With reference to FIGS. 7-9, a further aspect of a brake lever mechanism is indicated by reference number 200. The brake lever mechanism 200 is similar to the brake lever mechanism 100 shown in FIGS. 4-6 and therefore like parts are indicated by like reference numbers. However, the biasing member 150 in the brake lever mechanism 100 has been replaced in the brake lever mechanism 200 with a biasing member 250 that includes a rod 252, a pin 254, a coiled spring 256, and an adjustment nut 258. The rod 252 is pivotally connected at a first end 252A to the second lever arm 131 of the brake lever 118. The rod 252 extends through an aperture of the pin 254 which is pivotally connected to the mounting bracket 116. The adjustment nut 258 is threaded onto a threaded second end 252B of the rod 252. The coiled spring 256 is disposed between the pin 254 and the adjustment nut 258 about the rod 252. Pivoting the brake lever 118 from the disengaged position, shown in FIG. 8, to the engaged position, shown in FIG. 7, compresses the spring 256. Thus, the spring 256 generates a force resisting rotation of the brake lever 118 as the brake lever 118 moves from the disengaged position toward the engaged position, which thereby exerts torque on the brake lever 118. The amount of torque may be adjusted by tightening or loosening the adjustment nut 258 which compresses or expands the spring 256.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A motor vehicle electric park brake system, comprising:
a hand brake lever mechanism in electronic communication with a park brake, the hand brake lever mechanism including:
a brake lever pivotally supported to a mounting bracket;
a biasing member exerting a torque on the brake lever as the brake lever rotates from a disengaged position to an engaged position to simulate a mechanical connection between the brake lever mechanism and the park brake; and
an adjustment mechanism displaced to adjust the biasing member to change the torque on the brake lever.

2. The motor vehicle park brake system of claim 1, wherein:
the mounting bracket is fixed to a motor vehicle and includes a first bracket parallel to a second bracket; and
the first bracket includes a first hole and the second bracket includes a second hole, having the first hole coaxial with the second hole.

3. The motor vehicle park brake system of claim 2, wherein the brake lever includes a lever arm extending from a housing portion, the housing portion defining an inner cavity.

4. The motor vehicle park brake system of claim 3, further including a center support extending out from a side wall of the housing portion into the inner cavity, the center support open at opposed ends and hollow, wherein the center support includes a longitudinal slot that extends through the center support.

5. The motor vehicle park brake system of claim 4, further including a pivot pin pivotally supporting and connecting the brake lever to the mounting bracket, the pivot pin extending through the first and the second holes in the first and second brackets, and through the center support.

6. The motor vehicle park brake system of claim 5, wherein the pivot pin is fixed from rotating with respect to the mounting bracket, and wherein the pivot pin includes a groove formed in an outer surface of the pivot pin.

7. The motor vehicle park brake system of claim 6, wherein the biasing member defines a torsion spring, the torsion spring disposed about the center support and including an inner end and an outer end, the inner end extending through the longitudinal slot in the center support and engaging the groove of the pivot pin.

8. The motor vehicle park brake system of claim 7, wherein the adjustment mechanism includes a threaded bolt and an adjustment pin.

9. The motor vehicle park brake system of claim 8, wherein:
the threaded bolt extends through a bolt-hole in the housing portion into the inner cavity; and
the adjustment pin includes a threaded bolt-hole which receives the threaded bolt, the adjustment pin having a first end opposite a second end, the first end disposed in a first groove formed in the side wall of the housing portion and the second end disposed in a second groove formed in a side cover, the first and second grooves limiting travel of the adjustment pin.

10. The motor vehicle park brake system of claim 8, wherein the inner end of the torsion spring is fixed from movement with the mounting bracket and the outer end of the torsion spring is connected to the adjustment mechanism and moves with a rotation of the brake lever.

11. A motor vehicle electric park brake system, comprising:
a mounting bracket; and
a hand brake lever mechanism in electronic communication with a park brake, the hand brake lever mechanism including:
a brake lever pivotally supported to the mounting bracket;
at least one spring exerting a torque on the brake lever as the brake lever is rotated from a disengaged position to an engaged position to simulate a mechanical connection between the brake lever mechanism and the park brake; and
an adjustment mechanism displaced to adjust the at least one spring to change the torque on the brake lever;
wherein a first end of the at least one spring is fixed from movement to the mounting bracket and a second end of the at least one spring is connected to the adjustment mechanism and moves with a rotation of the brake lever.

12. The motor vehicle park brake system of claim 11, further including a pivot pin pivotally supporting and connecting the brake lever to the mounting bracket, the pivot pin fixed from rotating with respect to the mounting bracket.

13. The motor vehicle park brake system of claim 12, wherein the pivot pin includes a groove formed in an outer surface of the pivot pin, the second end of the at least one spring connected to the groove.

14. The motor vehicle park brake system of claim 12, wherein the pivot pin includes a groove formed in an outer surface of the pivot pin, and wherein the at least one spring defines a first torsion spring and a second torsion spring, the second end of each of the first torsion spring and the second torsion spring connected to the groove.

15. The motor vehicle park brake system of claim 11, wherein the brake lever includes a lever arm extending from a housing portion, the housing portion defining an inner cavity, and wherein the adjustment mechanism includes a threaded bolt and an adjustment pin, the threaded bolt extending through a bolt-hole in the housing portion.

16. The motor vehicle park brake system of claim 15, wherein the brake lever includes a lever arm extending from the housing portion having a hand grip disposed on a distal end of the lever arm.

17. The motor vehicle park brake system of claim 16, further including a second lever arm extending from the housing portion on a side of the housing portion opposite that of the lever arm, the spring including a first end pivotally connected to the mounting bracket and a second end pivotally connected to the second lever arm.

18. A motor vehicle electric park brake system, comprising:
a mounting bracket; and
a hand brake lever mechanism in electronic communication with a park brake, the hand brake lever mechanism including:
a brake lever pivotally supported to the mounting bracket;
a biasing member exerting a torque on the brake lever as the brake lever is rotated from a disengaged position to an engaged position to simulate a mechanical connection between the brake lever mechanism and the park brake;
an adjustment device displaced to adjust the biasing member to change the torque on the brake lever;
a pivot pin pivotally supporting and connecting the brake lever to the mounting bracket, the pivot pin fixed from rotating with respect to the mounting bracket;
a switch mounted to the brake lever; and
a sensor mounted to the mounting bracket, the sensor detecting a position of the switch and movement of the brake lever.

19. The motor vehicle park brake system of claim 18, wherein the biasing member includes a rod, a pin, a coiled spring, and an adjustment nut, and wherein pivoting the brake lever from the disengaged position to the engaged position compresses the biasing member.

20. The motor vehicle park brake system of claim 18, wherein the brake lever further includes a first lever arm and a second lever arm extending from the housing portion on a side of the housing portion opposite that of the first lever arm, the rod being pivotally connected at a first end to the second lever arm and extending through an aperture of the pin and pivotally connected to the mounting bracket, and the adjustment nut being threaded onto a threaded second end of the rod.
